(19) United States
(12) Patent Application Publication
(10) Pub. No.: US 2025/0153504 A1
(43) Pub. Date: May 15, 2025

(54) PAINT BY NUMBERS KIT APPLICABLE ON ANY SURFACE

(71) Applicant: uPaint LLC, Tripoli (LB)

(72) Inventors: Bahaa Eddine Mneymneh, Tripoli (LB); Mohamad Abbas, Tripoli (LB); Abdo Achkar, Tripoli (LB)

(21) Appl. No.: 18/507,471

(22) Filed: Nov. 13, 2023

(51) Int. Cl. B44D 2/00

(52) U.S. Cl. CPC B44D 2/002

(57) ABSTRACT

The present invention provides a sheet which makes it easy to paint on different surfaces including walls using the painting by numbers techniques.

According to an aspect of the present invention, there is provided a paint by numbers sheet for applying to a surface, comprising: a self-adhesive vinyl sheet backed by a release liner; a plurality of numbered regions on the sheet, wherein the numbered regions are individually cut; a transfer sheet; and a set of numbered acrylic paint cups.

### BACKGROUND

The prior art patent literature describes various improvements in “painting by numbers” type kits. Such kits comprise a base sheet which has a surface divided into various areas, and each area printed with an identification number. The number designates the appropriate paint color which should be applied to the area.

For example, U.S. Pat. No. 5,788,501 discloses support material for a painting comprises a substrate, e.g. of paper or card, having on regions thereof a removable masking material to provide pictorial content and to define non-masked regions of substrate which provide a surface for receiving and retaining paint, wherein the masking material is provided on the substrate in the form of a printed layer, applied for instance by screen printing. The preferred masking material is applied as a latex-based fluid and is removable from the substrate by an eraser after application of a water-based paint wash to the entire substrate surface. Optionally the subsequently unmasked regions can be painted to provide additional pictorial detail.

U.S. Pat. No. 4,165,408 discloses a method for decorating the border panel or any other area of a cardboard picture mat and the product of that method. Boundary lines of ink or other material are drawn to give a desired pattern and to define design areas. Then a finely divided pigmented powder is brushed into the areas which are desired to be colored. The paper surface holds only a limited amount of the powder, and excess powder is removed. The areas may be rubbed down to assure even distribution and to impart a desired brilliance or tone.

US20040067468 describes a coloring/painting system which has a picture material with a picture outline thereon. The picture outline has a plurality of picture areas where each picture area is outlined with a color indicative of the color to be applied thereto. A plurality of coloring media for applying to the plurality of picture areas is provided.

Nevertheless, prior art methods and systems do not allow for a paint by numbers type painting to be applied to a surface such as a wall.

### SUMMARY OF INVENTION

Therefore, the present invention provides a sheet which makes it easy to paint on different surfaces including walls using the painting by numbers techniques.

According to an aspect of the present invention, there is provided a paint by numbers sheet for applying to a surface, comprising: a self-adhesive vinyl sheet backed by a release liner; a plurality of numbered regions on the sheet, wherein the numbered regions are individually cut; a transfer sheet; and a set of numbered acrylic paint cups.

According to another aspect of the present invention, there is provided a method of manufacturing a paint by numbers sheet for applying to a surface, comprising: selecting an image; creating a layout of numbered regions using software that applies machine learning and image processing techniques to transform the image to numbered regions; printing the numbered regions on self-adhesive vinyl paper backed by a release liner using a Latex plotter; inserting the printed self-adhesive vinyl paper backed by a release liner in a cutting machine; and cutting out each of the numbered regions with a blade in the cutting machine.

According to yet another aspect of the present invention, there is provided a method of painting a surface, comprising: providing a paint by numbers sheet with a plurality of numbered regions on the sheet, wherein the numbered regions are individually cut; removing a release liner from the back of the self-adhesive vinyl sheet; applying the adhesive on the paint by numbers sheet to a surface; and removing a transfer film.

### BRIEF DESCRIPTION OF THE DRAWINGS

FIG. 1 illustrates a sheet according to an embodiment of the present invention.

FIG. 2 illustrates removing a numbered region from the surface on which the sheet has been applied.

FIG. 3 illustrates the painting process.

### DETAILED DESCRIPTION

Painting by numbers is a method where a painting is composed of numbered regions, where each number corresponds to a different color. Painting by numbers has typically been done on printable surfaces such as paper or canvas, with the outlines of the numbered regions printed directly on the printable surface.

The present invention creates a new tool to apply the same concept directly on walls or other surfaces which cannot practically be fed through a printer. The invention makes it possible to create a painting on any surface using paint by numbers.

The first step is to create a paint by numbers version of a painting, which may be a famous painting, for example. A software that applies machine learning and image processing techniques can transform any picture to numbered regions and then link each region with a specific color to automatically create a paint by numbers version of any picture.

Once the design is ready, a digital version with the black and white numbered regions can be printed on vinyl paper using a Latex plotter. After the printing process, the printed vinyl paper can be inserted in a cutting machine. The vinyl printed on is self-adhesive paper, so that the user does not have to apply adhesive to the back of the sheet, nor a release liner. Instead, it is self-adhesive with a release liner already attached.

A cutting machine can have a head with a knife blade that allows cutting into the vinyl. The depth of the blade can be adjusted according to the material used. The outline to be cut can be loaded in a specialized cutting design software program on a computer connected to the cutting machine. When cutting the regions with the machine, only the vinyl layer can be cut, and the release liner can stay intact in one piece.

After the printed vinyl paper is processed by the cutting machine, a sheet with numbered vinyl regions is ready to be stuck on any surface, such as a wall, glass, wood, etc.

In order to transfer the numbered vinyl regions and stick them on any surface (wall, glass, wood, etc.), a transfer film is provided. This transfer film can be applied on the numbered vinyl regions using a squeegee.

After applying the transfer film, we can now peel away the backing sheet of the vinyl paper (also known as release liner), and now the numbered vinyl regions are ready to be stuck on any surface (wall, glass, wood, etc.).

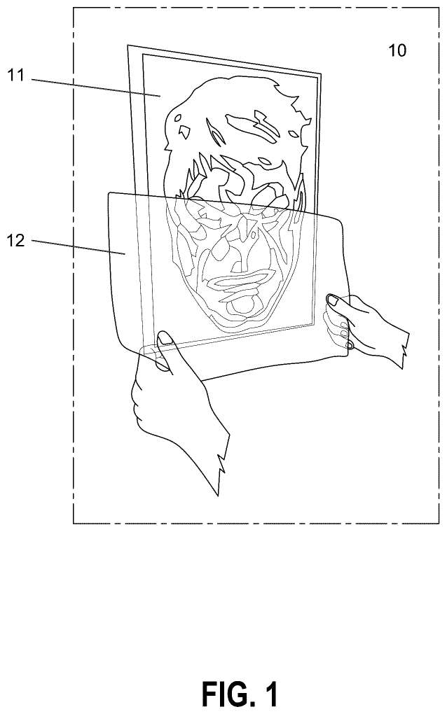

FIG. 1 illustrates a sheet according to an embodiment of the present invention.

Sheet 10 contains vinyl regions 11. The numbered vinyl regions can be stuck on any surface (wall, glass, wood, etc.). FIG. 1 shows how to stick the numbered vinyl paper on a wall. A squeegee can be used to avoid bubbles. After making sure that the numbered vinyl regions are stuck properly on the surface, a user can now remove transfer film 12 as shown in FIG. 1.

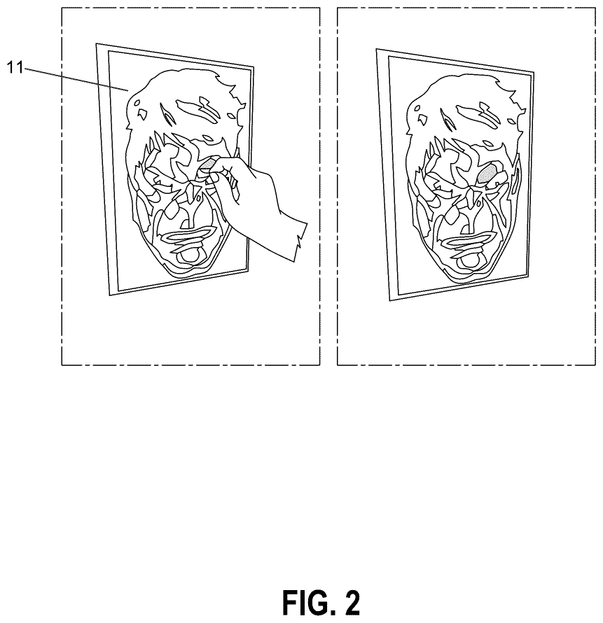

FIG. 2 illustrates removing a numbered region from the surface on which the sheet has been applied.

After sticking the numbered vinyl regions on the surface and removing the transfer film a user can start the painting process. The user can start by removing one numbered vinyl region at a time. FIG. 2 shows the removal of one numbered vinyl region 11. A vinyl scraper can be used to start the removal.

After removing the numbered vinyl region the user can start painting directly on the surface using paint from the provided numbered acrylic paint cups

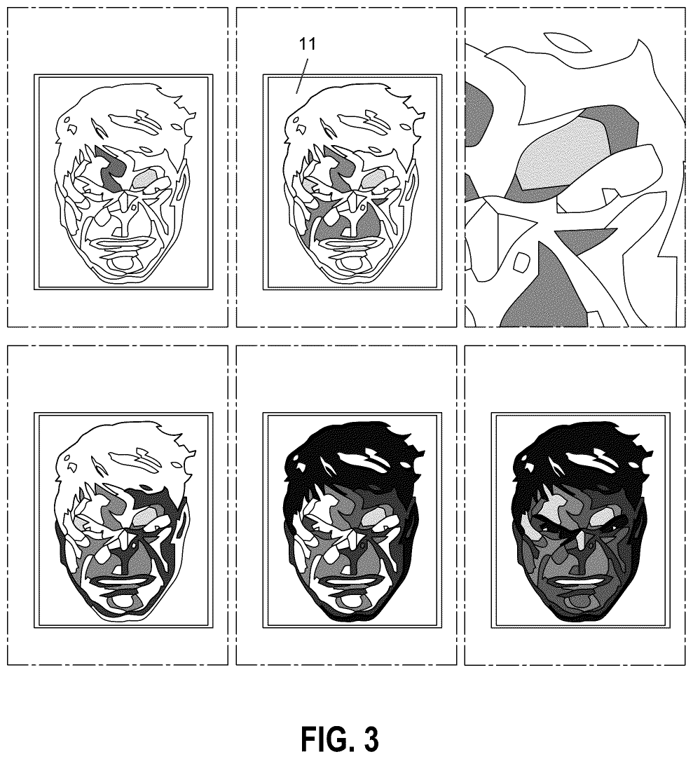

FIG. 3 illustrates the painting process.

Once one numbered region is finished, the user can move to another region, and continue painting until the user finishes all the regions. The end result is a painting painted directly on the surface (wall, glass, wood, etc.).

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Similar numerals designate similar elements among the several figures. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A paint by numbers sheet for applying to a surface, comprising:
a self-adhesive vinyl sheet, backed by a release liner
a plurality of numbered regions on the sheet, wherein the numbered regions are individually cut
a transfer sheet
a set of numbered acrylic paint cups

2. The sheet for applying to a surface of claim 1, wherein the paint by numbers sheet is self-adhesive vinyl.

3. The sheet for applying to a surface of claim 1, wherein the release liner is non-stick paper.

4. The sheet for applying to a surface of claim 1, wherein the transfer sheet is transparent.

5. A method of manufacturing a paint by numbers sheet for applying to a surface, comprising:
selecting an image;
creating a layout of numbered regions using software that applies machine learning and image processing techniques to transform the image to numbered regions;
printing the numbered regions on printed self-adhesive vinyl paper backed by a release liner using a Latex plotter;
inserting the printed self-adhesive vinyl paper backed by a release liner in a cutting machine; and
cutting out each of the numbered regions with a blade in the cutting machine.

6. The method of manufacturing a paint by numbers sheet for applying to a surface according to claim 5, further comprising applying a transfer sheet.

7. The method of manufacturing a paint by numbers sheet for applying to a surface according to claim 5, further comprising adjusting the depth of the blade.

8. The method of manufacturing a paint by numbers sheet for applying to a surface according to claim 5, wherein when cutting the regions with the machine only the vinyl layer is cut and the release liner stays intact in one piece.

9. A method of painting a surface, comprising:
providing a paint by numbers sheet with a plurality of numbered regions on the sheet, wherein the numbered regions are individually cut;
removing a release liner from an adhesive applied to the back of the sheet;
applying the adhesive on the paint by numbers sheet to a surface; and
removing a transfer film.

10. The method of painting a surface of claim 8, further comprising providing numbered acrylic paint cups corresponding to the numbered regions.
